(19) United States
(12) Patent Application Publication
(10) Pub. No.: US 2025/0294512 A1
(43) Pub. Date: Sep. 18, 2025

(54) RANGING SIDELINK POSITIONING METHOD, AND APPARATUS

(71) Applicant: Beijing Xiaomi Mobile Software Co., Ltd., Beijing (CN)

(72) Inventor: Yang SHEN, Beijing (CN)

(73) Assignee: Beijing Xiaomi Mobile Software Co., Ltd., Beijing (CN)

(21) Appl. No.: 18/862,621

(22) PCT Filed: May 6, 2022
(86) PCT No.: PCT/CN2022/091323

§ 371 Date: Nov. 4, 2024

(51) Int. Cl. H04W 64/00; H04W 72/25

(52) U.S. Cl. CPC H04W 64/003; H04W 72/25

(57) ABSTRACT

A ranging sidelink positioning method is provided. The method includes: sending a ranging/sidelink positioning capability request message to a first terminal device; receiving a ranging/sidelink positioning capability response message fed back by the first terminal device, the ranging/sidelink positioning capability response message including ranging/sidelink positioning capability information of at least one terminal device; and according to the ranging/sidelink positioning capability response message, determining calculation information for performing ranging/sidelink positioning for the first terminal device and at least one second terminal device.

### CROSS REFERENCE TO RELATED APPLICATION

The present application is a U.S. National Stage of International Application No. PCT/CN2022/091323, filed on May 6, 2022, the contents of which are incorporated herein by reference in its entirety.

### TECHNICAL FIELD

The present disclosure relates to the field of communication technologies, and in particular to a ranging sidelink positioning method, an apparatus, a device and a storage medium.

### BACKGROUND

In communication systems, both a Location Management Function (LMF) entity and a terminal device can perform ranging sidelink positioning. The ranging sidelink positioning refers to the calculation of result(s) between two terminal devices or between one terminal device and multiple terminal devices.

### SUMMARY

An embodiment of an aspect of the present disclosure provides a ranging sidelink positioning method. The method is performed by a Location Management Function (LMF) entity, and the method includes:
sending a ranging sidelink positioning capability request message to a first terminal device;
receiving a ranging sidelink positioning capability response message fed back by the first terminal device, wherein the ranging sidelink positioning capability response message includes ranging sidelink positioning capability information of at least one terminal device; and
according to the ranging sidelink positioning capability response message, determining calculation information for performing ranging sidelink positioning for the first terminal device and at least one second terminal device.

An embodiment of another aspect of the present disclosure provides a ranging sidelink positioning method. The method is performed by a first terminal device, and the method includes:
receiving a ranging sidelink positioning capability request message sent by LMF;
feeding back a ranging sidelink positioning capability response message to the LMF, wherein the ranging sidelink positioning capability response message includes at least one of the following:
a preferred calculation node for ranging sidelink positioning;
a calculation mode for the ranging sidelink positioning;
ranging sidelink positioning capability information of the first terminal device and/or at least one second terminal device.

An embodiment of another aspect of the present disclosure provides a ranging sidelink positioning apparatus. The apparatus includes:
a sending module configured to send a ranging sidelink positioning capability request message to the first terminal device;
a receiving module configured to receive a ranging sidelink positioning capability response message fed back by the first terminal device, wherein the ranging sidelink positioning capability response message includes ranging sidelink positioning capability information of at least one terminal device; and
a determination module configured to determine calculation information for performing ranging sidelink positioning for the first terminal device and at least one second terminal device according to the ranging sidelink positioning capability response message.

An embodiment of another aspect of the present disclosure provides a ranging sidelink positioning apparatus. The apparatus includes:
a receiving module configured to receive a ranging sidelink positioning capability request message sent by the LMF;
a sending module configured to feed back a ranging sidelink positioning capability response message to the LMF, wherein the ranging sidelink positioning capability response message includes at least one of the following:
a preferred calculation node for ranging sidelink positioning;
a calculation mode for the ranging sidelink positioning;
ranging sidelink positioning capability information of the first terminal device and/or at least one second terminal device.

Another aspect of the present disclosure provides a terminal device, the device includes a processor and a memory, the memory stores a computer program, and execution of the computer program stored in the memory by the processor causes the device to perform the methods provided in the embodiments of the above aspect.

Another aspect of the present disclosure provides an LMF, the device comprises a processor and a memory, the memory stores a computer program, and execution of the computer program stored in the memory causes the device to perform the methods provided in the embodiments of the another aspect.

An embodiment of another aspect of the present disclosure provides a communication apparatus. The apparatus includes: a processor and an interface circuit;
the interface circuit is configured to receive code instructions and transmit them to the processor;
the processor is configured to run the code instructions to perform the methods provided in the embodiments of the aspect.

An embodiment of another aspect of the present disclosure provides a communication apparatus. The apparatus includes: a processor and an interface circuit;
the interface circuit is configured to receive code instructions and transmit them to the processor;
the processor is configured to run the code instructions to perform the methods provided in the embodiments of the another aspect.

An embodiment of another aspect of the present disclosure provides a computer-readable storage medium. The computer-readable storage medium is configured to store instructions, and when the instructions are executed, the method provided in any one of the embodiments of the aspect is implemented.

An embodiment of another aspect of the present disclosure provides a computer-readable storage medium. The computer-readable storage medium is configured to store instructions, and when the instructions are executed, the method provided in any one of the embodiments of the another aspect is implemented.

### BRIEF DESCRIPTION OF THE DRAWINGS

The above and/or additional aspects and advantages of the present disclosure will become apparent and easily understood from the following description of the embodiments in conjunction with the accompanying drawings, in which:

FIG. 1 is a schematic flowchart of a ranging sidelink positioning method provided by an embodiment of the present disclosure;

FIG. 2 is a schematic flowchart of a ranging sidelink positioning method provided by another embodiment of the present disclosure;

FIG. 3 is a schematic flowchart of a ranging sidelink positioning method provided by yet another embodiment of the present disclosure;

FIG. 4 is a schematic flowchart of a ranging sidelink positioning method provided by yet another embodiment of the present disclosure;

FIG. 5 is a schematic flowchart of a ranging sidelink positioning method provided by yet another embodiment of the present disclosure;

FIG. 6 is a schematic flowchart of a ranging sidelink positioning method provided by yet another embodiment of the present disclosure;

FIG. 7 is a schematic flowchart of a ranging sidelink positioning method provided by yet another embodiment of the present disclosure;

FIG. 8 is a schematic flowchart of a ranging sidelink positioning method provided by yet another embodiment of the present disclosure;

FIG. 9 is a schematic flowchart of a ranging sidelink positioning method provided by yet another embodiment of the present disclosure;

FIG. 10 is a schematic flowchart of a ranging sidelink positioning method provided by yet another embodiment of the present disclosure;

FIG. 11 is a schematic structural diagram of a ranging sidelink positioning apparatus provided by an embodiment of the present disclosure;

FIG. 12 is a schematic structural diagram of a ranging sidelink positioning apparatus provided by another embodiment of the present disclosure;

FIG. 13 is a block diagram of a terminal device provided by an embodiment of the present disclosure;

FIG. 14 is a block diagram of a network side device provided by an embodiment of the present disclosure.

### DETAILED DESCRIPTION

Example embodiments will be described in detail herein, examples of which are shown in the accompanying drawings. When the following description refers to the drawings, the same numbers in different drawings represent the same or similar elements unless otherwise indicated. The implementations described in the following example embodiments do not represent all implementations consistent with the embodiments of the present disclosure. Instead, they are merely examples of devices and methods consistent with some aspects of the embodiments of the present disclosure as detailed in the appended claims.

The terms used in the embodiments of the present disclosure are only for the purpose of describing specific embodiments and are not intended to limit the embodiments of the present disclosure. The singular forms such as “a/an” and “the” used in the embodiments of the present disclosure and the appended claims are also intended to include plural forms unless the context clearly indicates other meanings. It should also be understood that the term “and/or” used herein refers to and includes any or all possible combinations of one or more associated listed items.

It should be understood that although the terms first, second, third, etc. may be used to describe various pieces of information in the embodiments of the present disclosure, these pieces of information should not be limited to these terms. These terms are only used to distinguish the same type of information from each other. For example, without departing from the scope of the embodiments of the present disclosure, first information may also be referred to as second information, and similarly, second information may also be referred to as first information. Depending on the context, the words “if” and “in a case where . . . ” as used herein may be interpreted as “upon” or “when” or “in response to determining . . . ”.

Network elements or network functions involved in the embodiments of the present disclosure may be implemented by independent hardware devices or by software in the hardware devices, and this is not limited in the embodiments of the present disclosure.

In the related art, since both a terminal device and a LMF can perform ranging sidelink positioning calculation(s), the calculation information for performing ranging sidelink positioning is not clarified for the terminal device and the LMF, and there may be situations where the calculation of ranging sidelink positioning cannot be carried out or is inaccurate. Therefore, there is an urgent need for a “ranging sidelink positioning” method to provide calculation information for ranging sidelink positioning of at least one terminal device to ensure the result calculation of the ranging sidelink positioning or improve the accuracy of the ranging sidelink positioning.

The following describes in detail a ranging sidelink positioning method, an apparatus, a device and a storage medium provided by embodiments of the present disclosure with reference to the accompanying drawings.

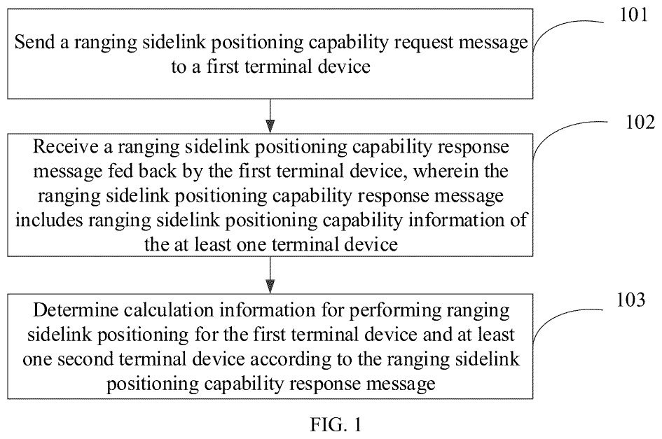

FIG. 1 is a schematic flowchart of a ranging sidelink positioning method provided by an embodiment of the present disclosure. The method is performed by a Location Management Function (LMF) entity. As shown in FIG. 1, the method may include the following steps:

In step 101, a ranging sidelink positioning capability request message is sent to a first terminal device.

It should be noted that, in an embodiment of the present disclosure, the terminal device may be a device that provides voice and/or data connectivity to a user. The terminal device may communicate with one or more core networks via a Radio Access Network (RAN). The terminal device may be an Internet of Things (IoT) terminal, such as a sensor device, a mobile phone (or called a “cellular” phone), and a computer with an IoT terminal, for example, it may be a fixed, portable, pocket-sized, handheld, computer-built-in, or vehicle-mounted device. For example, the terminal device may be a station (STA), a subscriber unit, a subscriber station, a mobile station, a mobile, a remote station, an access point, a remote terminal, an access terminal, a user terminal, or a user agent. Alternatively, the terminal device may be a device of an unmanned aerial vehicle. Alternatively, the terminal device may be a vehicle-mounted device, for example, it may be an onboard computer with a wireless communication function, or a wireless terminal connected to an external onboard computer. Alternatively, the terminal device may be a roadside device, for example, a street lamp, a traffic light or other roadside device with a wireless communication function.

It should be noted that, in an embodiment of the present disclosure, the first terminal device refers to a terminal device that communicates with the Location Management Function (LMF) entity. The term “first” is only used to indicate a terminal device that communicates with the LMF, and the first terminal device does not specifically refer to a certain terminal device constantly.

In an embodiment of the present disclosure, determining the calculation information for performing ranging sidelink positioning for the first terminal device and at least one second terminal device includes at least one of the following:
determining a calculation mode for performing ranging sidelink positioning for the first terminal device and the at least one second terminal device;
determining a calculation node for performing ranging sidelink positioning for the first terminal device and at least one second terminal device.

And, in an embodiment of the present disclosure, the calculation node includes one of the following:
using the terminal device as the calculation node for ranging sidelink positioning;
using the LMF as the calculation node for ranging sidelink positioning;
using at least one terminal device and the LMF as the calculation node for ranging sidelink positioning.

And, in an embodiment of the present disclosure, the calculation mode includes one of the following:
a calculation mode in which at least one terminal device performs ranging sidelink positioning;
a calculation mode in which the LMF performs ranging sidelink positioning;
a calculation mode in which the at least one terminal device and the LMF jointly perform ranging sidelink positioning.

And, in an embodiment of the present disclosure, determining the calculation node for performing ranging sidelink positioning for the first terminal device and at least one second terminal device includes:
receiving a preferred calculation node for ranging sidelink positioning sent by at least one terminal device;
if the preferred calculation node is at least one terminal device, using the corresponding at least one terminal device as the calculation node for performing ranging sidelink positioning for the first terminal device and the at least one second terminal device;
if the preferred calculation node is the LMF, using LMF as the calculation node for performing ranging sidelink positioning for the first terminal device and the at least one second terminal device;
if the preferred calculation node is the at least one terminal device and the LMF, using the at least one terminal device and the LMF as the calculation node for ranging sidelink positioning for the first terminal device and the at least one second terminal device.

And, in an embodiment of the present disclosure, the at least one terminal device includes the first terminal device and the at least one second terminal device;
the ranging sidelink positioning capability information includes at least one of the following:
ranging sidelink positioning capability information of the first terminal device in the at least one terminal device, wherein the first terminal device is a terminal device in the at least one terminal device that has a session connection with the LMF;
ranging sidelink positioning capability information of a second terminal device in the at least one terminal device, wherein the second terminal device is any terminal device in the at least one terminal device that performs ranging sidelink positioning with the first terminal device.

And, in an embodiment of the present disclosure, determining, according to the ranging sidelink positioning capability response message, the calculation information for performing ranging sidelink positioning for the first terminal device and the at least one second terminal device includes:
obtaining ranging sidelink positioning capability information of the LMF; and
according to the ranging sidelink positioning capability information of the at least one terminal device and the ranging sidelink positioning capability information of the LMF, determining the calculation information for performing ranging sidelink positioning for the first terminal device and the at least one second terminal device.

And, in an embodiment of the present disclosure, sending the ranging sidelink positioning capability request message to the first terminal device includes:
receiving a ranging sidelink positioning service request sent by an Access and Mobility management Function (AMF) entity;
in response to the ranging sidelink positioning service request, determining whether the LMF has available ranging sidelink positioning capability information of the first terminal device and the at least one second terminal device; and
in response to the LMF not having the available ranging sidelink positioning capability information of the first terminal device and the at least one second terminal device, sending the ranging sidelink positioning capability request message to the first terminal device.

And, in an embodiment of the present disclosure, the ranging sidelink positioning capability request message carries the ranging sidelink positioning capability information of the LMF as well as an identity of the first terminal device and an identity of the at least one second terminal device.

And, in an embodiment of the present disclosure, the ranging sidelink positioning capability information refers to calculation capability information for performing ranging sidelink positioning for the first terminal device and the at least one second terminal device through a direct communication PC5 interface, including at least one of the following:
a calculation of a general relative distance between the first terminal and any one of the at least one second terminal device;
a calculation of a general relative direction between the first terminal and any one of the at least one second terminal device;
a calculation of a high-accuracy relative distance between the first terminal and any one of the at least one second terminal device;
a calculation of a high-accuracy relative direction between the first terminal and any one of the at least one second terminal device;
a calculation of a general relative distance between the first terminal and a plurality of second terminal devices;
a calculation of a general relative direction between the first terminal and a plurality of second terminal devices;
a calculation of a high-accuracy relative distance between the first terminal and a plurality of second terminal devices;
a calculation of a high-accuracy relative direction between the first terminal and a plurality of second terminal devices;
where the first terminal device is a terminal device that has a session connection with the LMF, and the second terminal device is any terminal device among the at least one terminal device that performs ranging sidelink positioning with the first terminal device.

In step 102, a ranging sidelink positioning capability response message fed back by the first terminal device is received, wherein the ranging sidelink positioning capability response message includes ranging sidelink positioning capability information of the at least one terminal device.

In step 103, calculation information for performing ranging sidelink positioning for the first terminal device and at least one second terminal device is determined according to the ranging sidelink positioning capability response message.

In view of the above, in the embodiments of the present disclosure, a ranging sidelink positioning capability request message is sent to a first terminal device; a ranging sidelink positioning capability response message fed back by the first terminal device is received, wherein the ranging sidelink positioning capability response message includes ranging sidelink positioning capability information of at least one terminal device; and calculation information for ranging sidelink positioning for the first terminal device and the at least one second terminal device is determined according to the ranging sidelink positioning capability response message. In the embodiments of the present disclosure, by determining the calculation information for ranging sidelink positioning, the calculation information for performing ranging sidelink positioning for the first terminal device and the at least one second terminal device can be determined, thus reducing the situation where the calculation of ranging sidelink positioning cannot be carried out or is inaccurate due to unclear calculation information. The present disclosure provides a processing method for the situation of “ranging sidelink positioning” to provide the calculation information for performing ranging sidelink positioning for the first terminal device and the at least one second terminal device, so as to ensure the result calculation of the ranging sidelink positioning or improve the accuracy of the ranging sidelink positioning.

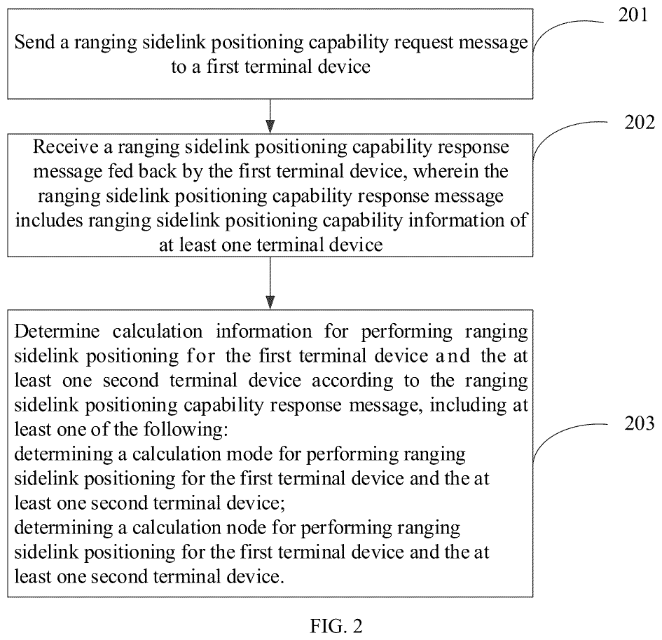

FIG. 2 is schematic flowchart of a ranging sidelink positioning method provided by an embodiment of the present disclosure. The method is performed by a LMF. As shown in FIG. 2, the method may include the following steps:

In step 201, a ranging sidelink positioning capability request message is sent to a first terminal device.

In step 202, a ranging sidelink positioning capability response message fed back by the first terminal device is received, wherein the ranging sidelink positioning capability response message includes ranging sidelink positioning capability information of at least one terminal device;

and, in an embodiment of the present disclosure, the ranging sidelink positioning capability information refers to information about a capability of performing ranging sidelink positioning for the first terminal device and the at least one second terminal device through a direct communication PC5 interface.

In step 203, calculation information for performing ranging sidelink positioning for the first terminal device and the at least one second terminal device is determined according to the ranging sidelink positioning capability response message, the determination including at least one of the following:
determining a calculation mode for performing ranging sidelink positioning for the first terminal device and the at least one second terminal device; or
determining a calculation node for performing ranging sidelink positioning for the first terminal device and the at least one second terminal device.

In an embodiment of the present disclosure, the calculation node includes one of the following:
using the terminal device as the calculation node for the ranging sidelink positioning;
using the LMF as the calculation node for the ranging sidelink positioning; or
using at least one terminal device and the LMF as the calculation node for the ranging sidelink positioning.

For example, in an embodiment of the present disclosure, the calculation mode includes one of the following:
a calculation mode in which the at least one terminal device performs the ranging sidelink positioning;
a calculation mode in which the LMF performs the ranging sidelink positioning;
a calculation mode in which the by at least one terminal device and the LMF jointly perform the ranging sidelink positioning.

For example, in an embodiment of the present disclosure, the calculation node refers to a node for performing ranging sidelink positioning. Since both the first terminal device and the LMF can perform ranging sidelink positioning, the node performing ranging sidelink positioning can be coordinated by the LMF between the first terminal device and the LMF.

For example, in an embodiment of the present disclosure, the LMF uses a terminal device as the calculation node for the ranging sidelink positioning, and this can also be understood as follows: the calculation mode determined by the LMF is a calculation mode in which at least one terminal device performs the ranging sidelink positioning.

For example, in an embodiment of the present disclosure, the LMF uses the LMF as the calculation node for the ranging sidelink positioning, and this can also be understood as follows: the calculation mode determined by the LMF is a calculation mode in which the LMF performs the ranging sidelink positioning.

For example, in an embodiment of the present disclosure, the LMF uses at least one terminal device and the LMF as the calculation node for the ranging sidelink positioning, and this can also be understood as follows: the calculation mode determined by the LMF is a calculation mode in which the at least one terminal device and the LMF jointly perform the ranging sidelink positioning.

Furthermore, in an embodiment of the present disclosure, using a terminal device as the calculation node for the ranging sidelink positioning may refer to that only the terminal device performs the ranging sidelink positioning, and only the terminal device obtains measurement data and determines the measurement result of the ranging sidelink positioning based on the measurement data.

In view of the above, in the embodiments of the present disclosure, a ranging sidelink positioning capability request message is sent to a first terminal device; a ranging sidelink positioning capability response message fed back by the first terminal device is received, wherein the ranging sidelink positioning capability response message includes ranging sidelink positioning capability information of at least one terminal device; and calculation information for ranging sidelink positioning for the first terminal device and at least one second terminal device is determined according to the ranging sidelink positioning capability response message. In the embodiments of the present disclosure, by determining the calculation information for ranging sidelink positioning, the calculation information for the ranging sidelink positioning for the first terminal device and the at least one second terminal device can be determined, thereby reducing the situation where the calculation of the ranging sidelink positioning cannot be carried out or is inaccurate due to unclear calculation information. The embodiments of the present disclosure disclose a specific scheme in which the calculation information includes a calculation mode and a calculation node. The present disclosure provides a processing method for the situation of “ranging sidelink positioning” to provide calculation information for the ranging sidelink positioning for the first terminal device and the at least one second terminal device, so as to ensure the result calculation of the ranging sidelink positioning or improve the accuracy of the ranging sidelink positioning.

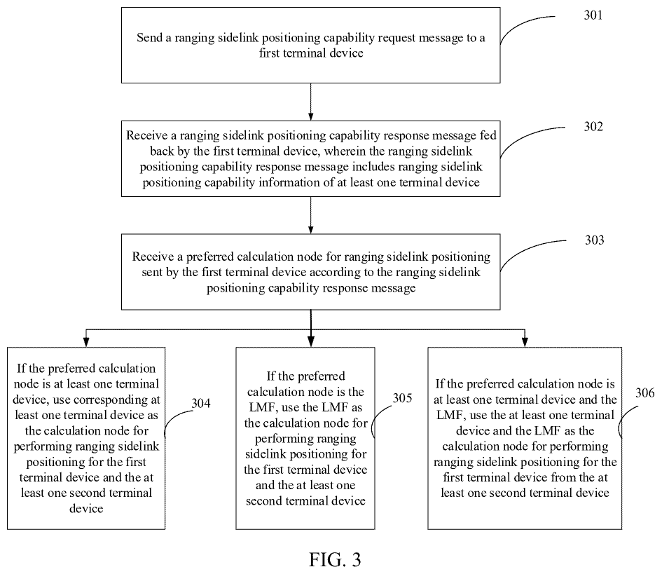

FIG. 3 is a schematic flowchart of a ranging sidelink positioning method provided by an embodiment of the present disclosure. The method is performed by a LMF. As shown in FIG. 3, the method may include the following steps:
In step 301, a ranging sidelink positioning capability request message is sent to a first terminal device.

In step 302, a ranging sidelink positioning capability response message fed back by the first terminal device is received, wherein the ranging sidelink positioning capability response message includes ranging sidelink positioning capability information of at least one terminal device.

In step 303, a preferred calculation node for ranging sidelink positioning sent by the first terminal device is received according to the ranging sidelink positioning capability response message.

One of the following steps is performed:
In step 304, if the preferred calculation node is at least one terminal device, corresponding at least one terminal device is used as the calculation node for performing ranging sidelink positioning for the first terminal device and the at least one second terminal device.

In step 305, if the preferred calculation node is the LMF, the LMF is used as the calculation node for performing ranging sidelink positioning for the first terminal device and the at least one second terminal device.

In step 306, if the preferred calculation node is at least one terminal device and the LMF, the at least one terminal device and the LMF are used as the calculation node for performing ranging sidelink positioning for the first terminal device and the at least one second terminal device.

In an embodiment of the present disclosure, the ranging sidelink positioning capability request message carries the ranging sidelink positioning capability information of the LMF, and the first terminal device can determine the preferred calculation node for ranging sidelink positioning based on the positioning capability information of the first terminal device and the ranging sidelink positioning capability information of the LMF, and send the preferred calculation node for ranging sidelink positioning to the LMF. The first terminal device can add the preferred calculation node for ranging sidelink positioning to the ranging sidelink positioning capability response message.

And, in an embodiment of the present disclosure, the LMF can determine the calculation node for performing ranging sidelink positioning for the first terminal device and the at least one second terminal device based on the preferred calculation node.

For example, in an embodiment of the present disclosure, the preferred calculation node is at least one terminal device and does not specifically refer to a certain terminal device constantly. That is, the preferred calculation node may be the first terminal device in the at least one terminal device, or may also be a second terminal device in the at least one terminal device. The first terminal device is a terminal device in the at least one terminal device that has a session connection with the LMF, and the second terminal device is any terminal device in the at least one terminal device that performs ranging sidelink positioning with the first terminal device.

In view of the above, in the embodiments of the present disclosure, a ranging sidelink positioning capability request message is sent to a first terminal device; a ranging sidelink positioning capability response message fed back by the first terminal device is received, wherein the ranging sidelink positioning capability response message includes ranging sidelink positioning capability information of at least one terminal device; and calculation information for performing ranging sidelink positioning for the first terminal device and at least one second terminal device is determined according to the ranging sidelink positioning capability response message. In the embodiments of the present disclosure, by determining the calculation information for ranging sidelink positioning, the calculation information for performing ranging sidelink positioning for the first terminal device and at least one second terminal device can be determined, thereby reducing the situation where the calculation of ranging sidelink positioning cannot be carried out or is inaccurate due to unclear calculation information. The embodiments of the present disclosure discloses a specific scheme for determining a calculation node based on a preferred calculation node. The present disclosure provides a processing method for the situation of “ranging sidelink positioning” to provide calculation information for performing ranging sidelink positioning for the first terminal device and the at least one second terminal device, so as to ensure the result calculation of the ranging sidelink positioning or improve the accuracy of ranging sidelink positioning.

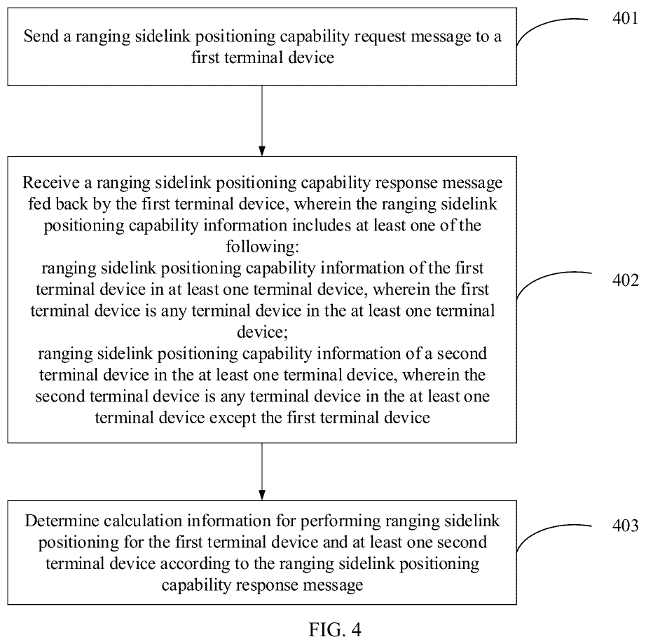

FIG. 4 is a schematic flowchart of a ranging sidelink positioning method provided by an embodiment of the present disclosure. The method is performed by a LMF. As shown in FIG. 4, the method may include the following steps:

In step 401, a ranging sidelink positioning capability request message is sent to a first terminal device.

In step 402, a ranging sidelink positioning capability response message fed back by the first terminal device is received, wherein the ranging sidelink positioning capability information includes at least one of the following:
ranging sidelink positioning capability information of the first terminal device in at least one terminal device, wherein the first terminal device is any terminal device in the at least one terminal device;
ranging sidelink positioning capability information of a second terminal device in the at least one terminal device, wherein the second terminal device is any terminal device in the at least one terminal device except the first terminal device.

In step 403, calculation information for performing ranging sidelink positioning for the first terminal device and at least one second terminal device is determined according to the ranging sidelink positioning capability response message.

In an embodiment of the present disclosure, the first terminal device may be any terminal device among the at least one terminal device. That is to say, the first terminal device does not specifically refer to a certain terminal device constantly. For example, when an identity of the first terminal device changes, the first terminal device may also change accordingly.

In an embodiment of the present disclosure, the second terminal device is any terminal device other than the first terminal device among the at least one terminal device, that is, the first terminal device and the second terminal device are different terminal devices.

For example, in an embodiment of the present disclosure, when at least one terminal device includes a terminal device A, a terminal device S, a terminal device D, and a terminal device F, the first terminal device may be for example the terminal device A, and the second terminal device may be for example the terminal device S. The first terminal device may be for example the terminal device D, and the second terminal device may be for example the terminal device S.

For example, in an embodiment of the present disclosure, the ranging sidelink positioning capability information refers to information about a calculation capability for performing ranging sidelink positioning for the first terminal device and the at least one second terminal device through a direct communication PC5 interface, and the calculation capability information includes at least one of the following:
a calculation of a general relative distance between the first terminal and any one of the at least one second terminal device;
a calculation of a general relative direction between the first terminal and any one of the at least one second terminal device;
a calculation of a high-accuracy relative distance between the first terminal and any one of the at least one second terminal device;
a calculation of a high-accuracy relative direction between the first terminal and any one of the at least one second terminal device;
a calculation of a general relative distance between the first terminal and a plurality of second terminal devices;
a calculation of a general relative direction between the first terminal and a plurality of second terminal devices;
a calculation of a high-accuracy relative distance between the first terminal and a plurality of second terminal devices;
a calculation of a high-accuracy relative direction of the first terminal and a plurality of second terminal devices;
where the first terminal device is a terminal device that has a session connection with the LMF, and the second terminal device is any terminal device among the at least one terminal device that performs ranging sidelink positioning with the first terminal device.

In view of the above, in the embodiments of the present disclosure, a ranging sidelink positioning capability request message is sent to a first terminal device; a ranging sidelink positioning capability response message fed back by the first terminal device is received, wherein the ranging sidelink positioning capability response message includes ranging sidelink positioning capability information of at least one terminal device; and calculation information for ranging sidelink positioning for the first terminal device and at least one second terminal device is determined according to the ranging sidelink positioning capability response message. In the embodiments of the present disclosure, by determining the calculation information for ranging sidelink positioning, the calculation information for performing ranging sidelink positioning for the first terminal device and at least one second terminal device can be determined, thereby reducing the situation where the calculation of the ranging sidelink positioning cannot be carried out or is inaccurate due to unclear calculation information. The embodiments of the present disclosure disclose a specific scheme for ranging sidelink positioning capability information, which can improve the accuracy of calculation information determination. The present disclosure provides a processing method for the situation of “ranging sidelink positioning” to provide the calculation information for performing ranging sidelink positioning for the first terminal device and the at least one second terminal device, so as to ensure the result calculation of the ranging sidelink positioning or improve the accuracy of ranging sidelink positioning.

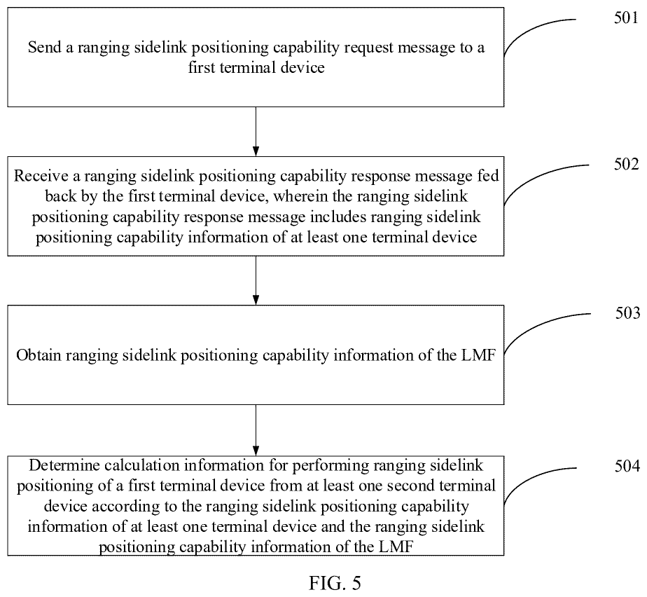

FIG. 5 is a schematic flowchart of a ranging sidelink positioning method provided by an embodiment of the present disclosure. The method is performed by a LMF. As shown in FIG. 5, the method may include the following steps:
In step 501, a ranging sidelink positioning capability request message is sent to a first terminal device.

In step 502, a ranging sidelink positioning capability response message fed back by the first terminal device is received, wherein the ranging sidelink positioning capability response message includes ranging sidelink positioning capability information of at least one terminal device.

In step 503, ranging sidelink positioning capability information of the LMF is obtained.
In step 504, calculation information for performing ranging sidelink positioning for a first terminal device and at least one second terminal device is determined according to the ranging sidelink positioning capability information of at least one terminal device and the ranging sidelink positioning capability information of the LMF.

For example, in an embodiment of the present disclosure, the ranging sidelink positioning capability information of the terminal device refers to capability information that the terminal device can perform ranging sidelink positioning for the first terminal device and at least one second terminal device through the direct communication PC5 interface. The ranging sidelink positioning capability information of the LMF refers to calculation capability information of the LMF to perform ranging sidelink positioning for the first terminal device and the at least one second terminal device through the direct communication PC5 interface.

For example, in an embodiment of the present disclosure, when the LMF determines calculation information for performing ranging sidelink positioning for the first terminal device and the at least one second terminal device according to the ranging sidelink positioning capability information of at least one terminal device and the ranging sidelink positioning capability information of the LMF, if it is determined that only the ranging sidelink positioning capability information of at least one terminal device is received, the calculation mode in which the at least one terminal device performs ranging sidelink positioning is determined as the calculation information for performing ranging sidelink positioning for the first terminal device and the at least one second terminal device, or the terminal device is determined as the calculation node for ranging sidelink positioning to determine the calculation information for performing ranging sidelink positioning for the first terminal device and the at least one second terminal device.

For example, in an embodiment of the present disclosure, when the LMF determines the calculation information for performing ranging sidelink positioning for the first terminal device and the at least one second terminal device according to the ranging sidelink positioning capability information of at least one terminal device and the ranging sidelink positioning capability information of the LMF, if it is determined that only the ranging sidelink positioning capability information of the LMF is received, the calculation mode in which the LMF performs ranging sidelink positioning is determined as the calculation information for performing ranging sidelink positioning for the first terminal device and the at least one second terminal device, or the LMF is determined as the calculation node for ranging sidelink positioning to determine the calculation information for performing ranging sidelink positioning for the first terminal device and the at least one second terminal device.

For example, in an embodiment of the present disclosure, when the LMF determines the calculation information for performing ranging sidelink positioning for the first terminal device and the at least one second terminal device according to the ranging sidelink positioning capability information of at least one terminal device and the ranging sidelink positioning capability information of the LMF, if it is determined that the ranging sidelink positioning capability information of at least one terminal device and the ranging sidelink positioning capability information of the LMF are received, the calculation information for performing ranging sidelink positioning for the first terminal device and the at least one second terminal device can be determined according to the preferred calculation node for ranging sidelink positioning sent by the first terminal device.

In view of the above, in the embodiments of the present disclosure, a ranging sidelink positioning capability request message is sent to a first terminal device; a ranging sidelink positioning capability response message fed back by the first terminal device is received, wherein the ranging sidelink positioning capability response message includes the ranging sidelink positioning capability information of at least one terminal device; and calculation information for performing ranging sidelink positioning for the first terminal device and at least one second terminal device is determined according to the ranging sidelink positioning capability response message. In the embodiments of the present disclosure, by determining the calculation information for the ranging sidelink positioning, the calculation information for performing ranging sidelink positioning for the first terminal device and the at least one second terminal device can be determined, thereby reducing the situation where calculation of the ranging sidelink positioning cannot be carried out or is inaccurate due to unclear calculation information. The embodiments of the present disclosure disclose a specific scheme for determining the calculation information according to the ranging sidelink positioning capability information of at least one terminal device and the ranging sidelink positioning capability information of the LMF, which can improve the accuracy of determining the calculation information. The present disclosure provides a processing method for the “ranging sidelink positioning” scenario to provide calculation information for performing ranging sidelink positioning for the first terminal device and the at least one second terminal device to ensure the result calculation of the ranging sidelink positioning or improve the accuracy of the ranging sidelink positioning.

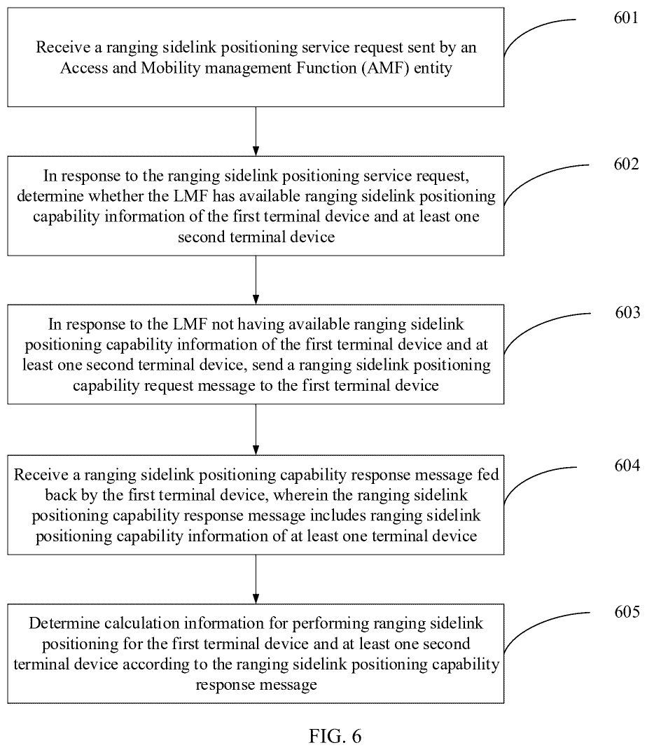

FIG. 6 is a schematic flowchart of a ranging sidelink positioning method provided by an embodiment of the present disclosure. The method is performed by a LMF. As shown in FIG. 6, the method may include the following steps:
In step 601, a ranging sidelink positioning service request sent by an Access and Mobility management Function (AMF) entity is received.

In step 602, in response to the ranging sidelink positioning service request, whether the LMF has available ranging sidelink positioning capability information of the first terminal device and at least one second terminal device is determined.

In step 603, in response to the LMF not having available ranging sidelink positioning capability information of the first terminal device and at least one second terminal device, a ranging sidelink positioning capability request message is sent to the first terminal device.

In step 604, a ranging sidelink positioning capability response message fed back by the first terminal device is received, wherein the ranging sidelink positioning capability response message includes ranging sidelink positioning capability information of at least one terminal device.

In step 605, calculation information for performing ranging sidelink positioning for the first terminal device and at least one second terminal device is determined according to the ranging sidelink positioning capability response message.

Secondly, in an embodiment of the present disclosure, the ranging sidelink positioning capability request message carries the ranging sidelink positioning capability information of the LMF as well as an identity of the first terminal device and an identity of at least one second terminal device.

For example, the identity of the first terminal device refers to a device identity corresponding to the first terminal device. The identity of the second terminal device refers to a device identity corresponding to the second terminal device. The expression “the at least one second terminal device” means that the number of second terminal device(s) is at least one. The identity of the first terminal device does not specifically refer to a terminal identity constantly. For example, when the first terminal device changes, the identity of the first terminal device may also change accordingly.

In view of the above, in the embodiments of the present disclosure, a ranging sidelink positioning capability request message is sent to a first terminal device; a ranging sidelink positioning capability response message fed back by the first terminal device is received, wherein the ranging sidelink positioning capability response message includes ranging sidelink positioning capability information of at least one terminal device; and calculation information for performing ranging sidelink positioning for the first terminal device and at least one second terminal device is determined according to the ranging sidelink positioning capability response message. In the embodiments of the present disclosure, by determining the calculation information for the ranging sidelink positioning, the calculation information for performing ranging sidelink positioning for the first terminal device and at least one second terminal device can be determined, thereby reducing the situation where the calculation of the ranging sidelink positioning cannot be carried out or is inaccurate due to unclear calculation information. The embodiments of the present disclosure disclose a specific scheme for sending a ranging sidelink positioning capability request message to the first terminal device according to whether the LMF has the available ranging sidelink positioning capability information of the first terminal device and at least one second terminal device, which can improve the accuracy of sending the ranging sidelink positioning capability request message and can also improve the accuracy of determining the calculation information. The present disclosure provides a processing method for the “ranging sidelink positioning” scenario to provide calculation information for performing ranging sidelink positioning for the first terminal device and at least one second terminal device to ensure the result calculation of the ranging sidelink positioning or improve the accuracy of the ranging sidelink positioning.

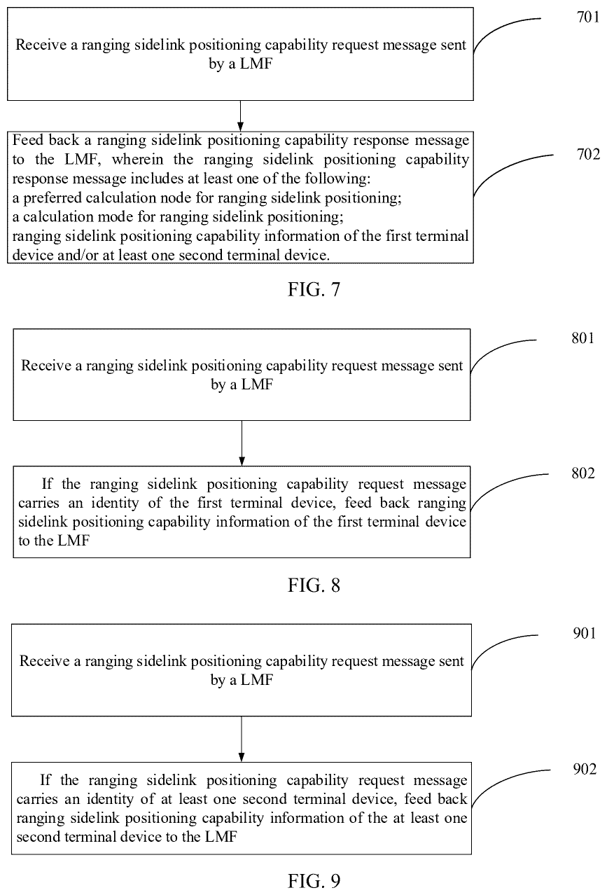

FIG. 7 is a schematic flowchart of a ranging sidelink positioning method provided by an embodiment of the present disclosure. The method is performed by a first terminal device. As shown in FIG. 7, the method may include the following steps:
In step 701, a ranging sidelink positioning capability request message sent by LMF is received.

In step 702, a ranging sidelink positioning capability response message is fed back to the LMF, wherein the ranging sidelink positioning capability response message includes at least one of the following:
a preferred calculation node for ranging sidelink positioning;
a calculation mode for ranging sidelink positioning;
ranging sidelink positioning capability information of the first terminal device and/or at least one second terminal device.

Secondly, in an embodiment of the present disclosure, the method further includes:

according to ranging sidelink positioning capability information of the LMF in the ranging sidelink positioning capability request message, determining the preferred calculation node or calculation mode for ranging sidelink positioning.

And, in an embodiment of the present disclosure, the method further includes:
if the ranging sidelink positioning capability request message carries an identity of at least one second terminal device, feeding ranging sidelink positioning capability information of the at least one second terminal device back to the LMF.

And, in an embodiment of the present disclosure, before feeding back the ranging sidelink positioning capability information of at least one second terminal device to the LMF, the method further includes:
if the first terminal device does not have available ranging sidelink positioning capability information of the at least one second terminal device, sending a positioning capability request message to the at least one second terminal device; and
receiving ranging sidelink positioning capability information sent by the at least one second terminal device.

And, in an embodiment of the present disclosure, the ranging sidelink positioning capability information refers to calculation capability information of performing ranging sidelink positioning for the first terminal device and at least one second terminal device through the direct communication PC5 interface.

In view of the above, in the embodiments of the present disclosure, a ranging sidelink positioning capability request message sent by a LMF is received; a ranging sidelink positioning capability response message is fed back to the LMF, wherein the ranging sidelink positioning capability response message includes at least one of the following: a preferred calculation node for ranging sidelink positioning; a calculation mode for ranging sidelink positioning; or ranging sidelink positioning capability information of the first terminal device and/or at least one second terminal device. In the embodiments of the present disclosure, by feeding back the ranging sidelink positioning capability response message to the LMF, the LMF can determine the calculation information for performing ranging sidelink positioning for the first terminal device and the at least one second terminal device, thereby reducing the situation where the calculation of ranging sidelink positioning cannot be carried out or is inaccurate due to unclear calculation information, and improving the accuracy of the calculation information determination. The present disclosure provides a processing method for the situation of “ranging sidelink positioning” to provide calculation information for performing ranging sidelink positioning for the first terminal device and at least one second terminal device, so as to ensure the result calculation of the ranging sidelink positioning or improve the accuracy of ranging sidelink positioning.

FIG. 8 is a schematic flowchart of a ranging sidelink positioning method provided by an embodiment of the present disclosure. The method is performed by a first terminal device. As shown in FIG. 8, the method may include the following steps:
In step 801, a ranging sidelink positioning capability request message sent by a LMF is received.

In step 802, if the ranging sidelink positioning capability request message carries an identity of the first terminal device, ranging sidelink positioning capability information of the first terminal device is fed back to the LMF.

For other detailed descriptions of step 801 to step 802, reference may be made to descriptions of the above embodiments, and repeated descriptions are not provided in detail here.

In view of the above, in the embodiments of the present disclosure, a ranging sidelink positioning capability request message sent by a LMF is received; and a ranging sidelink positioning capability response message is fed back to the LMF, wherein the ranging sidelink positioning capability response message includes at least one of the following: a preferred calculation node for ranging sidelink positioning; a calculation mode for ranging sidelink positioning; and ranging sidelink positioning capability information of the first terminal device and/or at least one second terminal device. In the embodiments of the present disclosure, by feeding back the ranging sidelink positioning capability response message to the LMF, the LMF can determine the calculation information for performing ranging sidelink positioning for the first terminal device and the at least one second terminal device, thereby reducing the situation where the calculation of ranging sidelink positioning cannot be carried out or is inaccurate due to unclear calculation information, and improving the accuracy of the calculation information determination. The embodiments of the present disclosure disclose a specific scheme for feeding back the ranging sidelink positioning capability information of the first terminal device to the LMF based on the identity of the first terminal device. The present disclosure provides a processing method for the “ranging sidelink positioning” scenario to provide calculation information for performing ranging sidelink positioning for the first terminal device and at least one second terminal device to ensure the result calculation of the ranging sidelink positioning or improve the accuracy of the ranging sidelink positioning.

FIG. 9 is a schematic flowchart of a ranging sidelink positioning method provided by an embodiment of the present disclosure. The method is performed by a first terminal device. As shown in FIG. 9, the method may include the following steps:
In step 901, a ranging sidelink positioning capability request message sent by a LMF is received.

In step 902, if the ranging sidelink positioning capability request message carries an identity of at least one second terminal device, ranging sidelink positioning capability information of the at least one second terminal device is fed back to the LMF.

For other detailed descriptions of step 901 to step 902, reference may be made to the descriptions of above embodiments, and repeated descriptions are not provided in detail here.

In view of the above, in the embodiments of the present disclosure, a ranging sidelink positioning capability request message sent by a LMF is received; and a ranging sidelink positioning capability response message is fed back to the LMF, wherein the ranging sidelink positioning capability response message includes at least one of the following: a preferred calculation node for ranging sidelink positioning; a calculation mode for ranging sidelink positioning; and ranging sidelink positioning capability information of the first terminal device and/or at least one second terminal device. In the embodiments of the present disclosure, by feeding back the ranging sidelink positioning capability response message to the LMF, the LMF can determine the calculation information for performing ranging sidelink positioning for the first terminal device and at least one second terminal device, thereby reducing the situation where the calculation of the ranging sidelink positioning cannot be carried out or is inaccurate due to unclear calculation information, and improving the accuracy of the calculation information determination. The embodiments of the present disclosure disclose a specific scheme for feeding back the ranging sidelink positioning capability information of at least one second terminal device to the LMF based on the identity of the at least one second terminal device. The present disclosure provides a processing method for the “ranging sidelink positioning” scenario to provide calculation information for performing ranging sidelink positioning for the first terminal device and at least one second terminal device to ensure the result calculation of the ranging sidelink positioning or improve the accuracy of the ranging sidelink positioning.

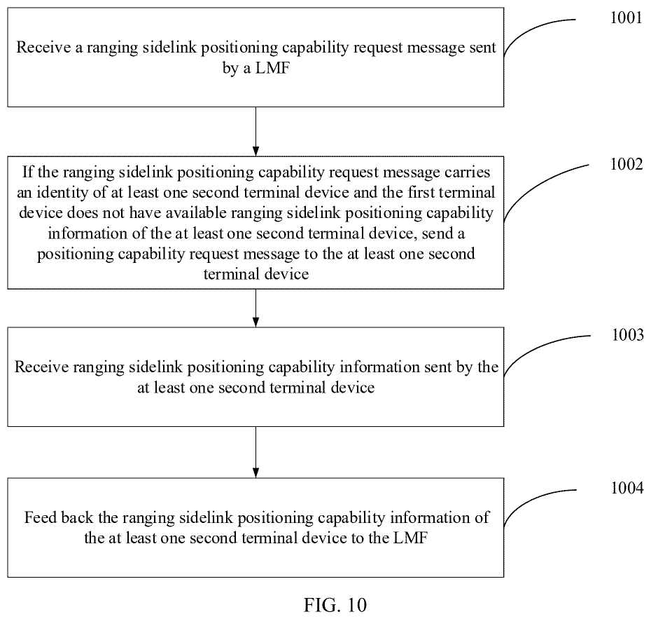

FIG. 10 is a schematic flowchart of a ranging sidelink positioning method provided by an embodiment of the present disclosure. The method is performed by a first terminal device. As shown in FIG. 10, the method may include the following steps:
In step 1001, a ranging sidelink positioning capability request message sent by a LMF is received.

In step 1002, if the ranging sidelink positioning capability request message carries an identity of at least one second terminal device and the first terminal device does not have available ranging sidelink positioning capability information of the at least one second terminal device, a positioning capability request message is sent to the at least one second terminal device.

In step 1003, ranging sidelink positioning capability information sent by the at least one second terminal device is received.

In step 1004, the ranging sidelink positioning capability information of the at least one second terminal device is fed back to the LMF.

In an embodiment of the present disclosure, if the ranging sidelink positioning capability request message carries an identity of at least one second terminal device, the first terminal device can detect whether there is ranging sidelink positioning capability information of the at least one second terminal device available in the first terminal device. If there is no ranging sidelink positioning capability information of the at least one second terminal device available in the first terminal device, the first terminal device can send a positioning capability request message to the at least one second terminal device. The positioning capability request message is used to request the ranging sidelink positioning capability information of the at least one terminal device. After receiving the ranging sidelink positioning capability information sent by the at least one second terminal device, the first terminal device can feed back the ranging sidelink positioning capability information of the at least one second terminal device to the LMF.

In view of the above, in the embodiments of the present disclosure, a ranging sidelink positioning capability request message sent by a LMF is received; and a ranging sidelink positioning capability response message is fed back to the LMF, wherein the ranging sidelink positioning capability response message includes at least one of the following: a preferred calculation node for ranging sidelink positioning; a calculation mode for ranging sidelink positioning; and ranging sidelink positioning capability information of the first terminal device and/or at least one second terminal device. In the embodiments of the present disclosure, by feeding back the ranging sidelink positioning capability response message to the LMF, the LMF can determine the calculation information for performing ranging sidelink positioning for the first terminal device and at least one second terminal device, thereby reducing the situation where the calculation of ranging sidelink positioning cannot be carried out or is inaccurate due to unclear computing information, and improving the accuracy of calculation information determination. The embodiments of the present disclosure disclose a specific scheme for receiving ranging sidelink positioning capability information sent by at least one second terminal device if there is no available ranging sidelink positioning capability information of at least one second terminal device in the first terminal device. The present disclosure provides a processing method for the “ranging sidelink positioning” scenario to provide calculation information for performing ranging sidelink positioning for the first terminal device and at least one second terminal device to ensure the result calculation of the ranging sidelink positioning or improve the accuracy of the ranging sidelink positioning.

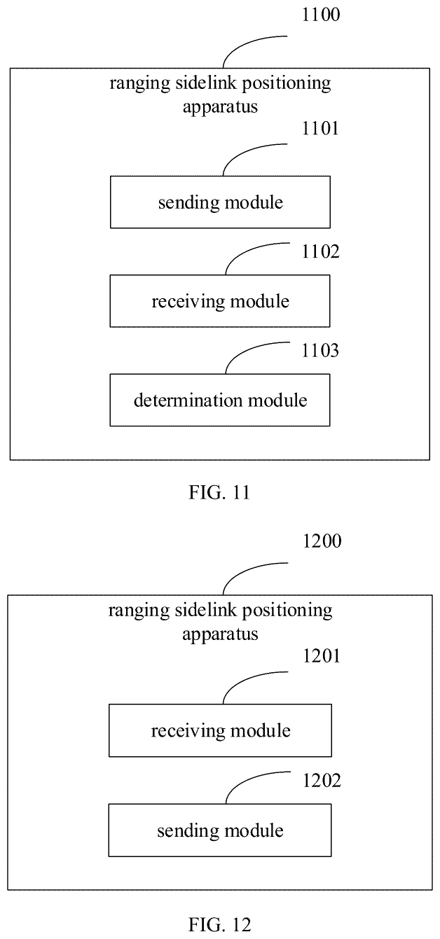

FIG. 11 is a schematic structural diagram of a ranging sidelink positioning apparatus provided by an embodiment of the present disclosure. As shown in FIG. 11, the apparatus 1100 may include: a sending module 1101, a receiving module 1102 and a determination module 1103.

The sending module 1101 is configured to send a ranging sidelink positioning capability request message to a first terminal device.

The receiving module 1102 is configured to receive a ranging sidelink positioning capability response message fed back by the first terminal device, wherein the ranging sidelink positioning capability response message includes ranging sidelink positioning capability information of at least one terminal device.

The determination module 1103 is configured to determine calculation information for performing ranging sidelink positioning for the first terminal device and at least one second terminal device according to the ranging sidelink positioning capability response message.

In view of the above, in the ranging sidelink positioning apparatus of the embodiment of the present disclosure, a ranging sidelink positioning capability request message can be sent to a first terminal device; a ranging sidelink positioning capability response message fed back by the first terminal device is received, wherein the ranging sidelink positioning capability response message includes ranging sidelink positioning capability information of at least one terminal device; and calculation information for performing ranging sidelink positioning for the first terminal device and at least one second terminal device is determined according to the ranging sidelink positioning capability response message. In the embodiment of the present disclosure, by determining the calculation information for ranging sidelink positioning, the calculation information for performing ranging sidelink positioning for the first terminal device and at least one second terminal device can be determined, thereby reducing the situation where calculation of the ranging sidelink positioning cannot be carried out or is inaccurate due to unclear calculation information. The present disclosure provides a processing device for the situation of “ranging sidelink positioning” to provide calculation information for performing ranging sidelink positioning for the first terminal device and at least one second terminal device, so as to ensure the result calculation of ranging sidelink positioning or improve the accuracy of ranging sidelink positioning.

Optionally, in an embodiment of the present disclosure, the determination module 1103 is configured to determine the calculation information for performing ranging sidelink positioning for the first terminal device and at least one second terminal device, including at least one of the following:
determining a calculation mode for performing ranging sidelink positioning for the first terminal device and at least one second terminal device; or
determining a calculation node for performing ranging sidelink positioning for the first terminal device and at least one second terminal device.

Optionally, in an embodiment of the present disclosure, the calculation node includes one of the following:
using the terminal device as the calculation node for ranging sidelink positioning;
using the LMF as the calculation node for ranging sidelink positioning; or
using at least one terminal device and the LMF as the calculation node for ranging sidelink positioning.

Optionally, in an embodiment of the present disclosure, the calculation mode includes one of the following:
a calculation mode in which the at least one terminal device performs ranging sidelink positioning;
a calculation mode in which the LMF performs ranging sidelink positioning; or
a calculation mode in which the at least one terminal device and the LMF jointly perform ranging sidelink positioning.

Optionally, in an embodiment of the present disclosure, when the determination module 1103 is configured to determine the calculation node for performing ranging sidelink positioning for the first terminal device and the at least one second terminal device, the determination module 1103 is specifically configured to:
receive a preferred calculation node for ranging sidelink positioning sent by at least one terminal device;
if the preferred calculation node is at least one terminal device, use the corresponding at least one terminal device as the calculation node for performing ranging sidelink positioning for the first terminal device and the at least one second terminal device;
if the preferred calculation node is the LMF, use the LMF as the calculation node for performing ranging sidelink positioning for the first terminal device and the at least one second terminal device;
if the preferred calculation node is the at least one terminal device and the LMF, use the at least one terminal device and the LMF as the calculation node for performing ranging sidelink positioning for the first terminal device and the at least one second terminal device.

Optionally, in an embodiment of the present disclosure, the at least one terminal device includes the first terminal device and the at least one second terminal device;
the ranging sidelink positioning capability information includes at least one of the following:
ranging sidelink positioning capability information of the first terminal device in the at least one terminal device, wherein the first terminal device is a terminal device in the at least one terminal device that has a session connection with the LMF; or
ranging sidelink positioning capability information of a second terminal device in the at least one terminal device, wherein the second terminal device is any terminal device in the at least one terminal device that performs ranging sidelink positioning with the first terminal device.

Optionally, in an embodiment of the present disclosure, when the determination module 1103 is configured to determine, according to the ranging sidelink positioning capability response message, the calculation information for performing ranging sidelink positioning for the first terminal device and the at least one second terminal device, the determination module 1103 is specifically configured to:
obtain the ranging sidelink positioning capability information of the LMF; and
according to the ranging sidelink positioning capability information of the at least one terminal device and the ranging sidelink positioning capability information of the LMF, determine the calculation information for performing ranging sidelink positioning for the first terminal device and the at least one second terminal device.

Optionally, in an embodiment of the present disclosure, when the sending module 1101 is configured to send the ranging sidelink positioning capability request message to the first terminal device, the sending module 1101 is specifically configured to:
receive a ranging sidelink positioning service request sent by an Access and Mobility management Function (AMF) entity;
in response to the ranging sidelink positioning service request, determine whether the LMF has available ranging sidelink positioning capability information of the first terminal device and at least one second terminal device; and
in response to the LMF not having the available ranging sidelink positioning capability information of the first terminal device and at least one second terminal device, send the ranging sidelink positioning capability request message to the first terminal device.

Optionally, in an embodiment of the present disclosure, the ranging sidelink positioning capability request message carries the ranging sidelink positioning capability information of the LMF as well as an identity of the first terminal device and an identity of at least one second terminal device.

Optionally, in an embodiment of the present disclosure, the ranging sidelink positioning capability information refers to calculation capability information for performing ranging sidelink positioning for the first terminal device and at least one second terminal device through the direct communication PC5 interface, including at least one of the following:
a calculation of a general relative distance between the first terminal and any second terminal device;
a calculation of a general relative direction between the first terminal and any second terminal device;
a calculation of a high-accuracy relative distance between the first terminal and any second terminal device;
a calculation of a high-accuracy relative direction between the first terminal and any second terminal device;
a calculation of a general relative distance between the first terminal and a plurality of second terminal devices;
a calculation of a general relative direction of the first terminal and a plurality of second terminal devices;
a calculation of a high-accuracy relative distance between the first terminal and a plurality of second terminal devices;
a calculation of a high-accuracy relative direction of the first terminal and a plurality of second terminal devices;
where the first terminal device is a terminal device that has a session connection with the LMF, and the second terminal device is any terminal device among the at least one terminal device that is involved in ranging sidelink positioning of the first terminal device.

FIG. 12 is a ranging sidelink positioning apparatus provided by an embodiment of the present disclosure. As shown in FIG. 12, the apparatus 1200 may include: a receiving module 1201 and a sending module 1202.

The receiving module 1201 is configured to receive a ranging sidelink positioning capability request message sent by a LMF.

The sending module 1202 is configured to feed back a ranging sidelink positioning capability response message to the LMF, wherein the ranging sidelink positioning capability response message includes at least one of the following:
a preferred calculation node for ranging sidelink positioning;
a calculation mode for ranging sidelink positioning;
ranging sidelink positioning capability information of a first terminal device and/or at least one second terminal device.

In view of the above, in the ranging sidelink positioning apparatus of the embodiment of the present disclosure, the receiving module can receive a ranging sidelink positioning capability request message sent by a LMF; the sending module can feed back a ranging sidelink positioning capability response message to the LMF, wherein the ranging sidelink positioning capability response message includes at least one of the following: a preferred calculation node for ranging sidelink positioning; a calculation mode for ranging sidelink positioning; or ranging sidelink positioning capability information of a first terminal device and/or at least one second terminal device. In the embodiments of the present disclosure, by feeding back the ranging sidelink positioning capability response message to the LMF, the LMF can determine the calculation information for ranging sidelink positioning for the first terminal device and at least one second terminal device, thereby reducing the situation where calculation of the ranging sidelink positioning cannot be carried out or is inaccurate due to unclear calculation information, and improving the accuracy of the calculation information determination. The present disclosure provides a processing apparatus for the situation of “ranging sidelink positioning” to provide calculation information for performing ranging sidelink positioning for the first terminal device and at least one second terminal device, so as to ensure the result calculation of the ranging sidelink positioning or improve the accuracy of ranging sidelink positioning.

Optionally, in an embodiment of the present disclosure, the sending module 1202 is further configured to determine the preferred calculation node or calculation mode for ranging sidelink positioning according to the ranging sidelink positioning capability information of the LMF in the ranging sidelink positioning capability request message.

Optionally, in an embodiment of the present disclosure, the sending module 1202 is further configured to feed back the ranging sidelink positioning capability information of the first terminal device to the LMF if the ranging sidelink positioning capability request message carries an identity of the first terminal device.

Optionally, in an embodiment of the present disclosure, the sending module 1202 is further configured to feed back the ranging sidelink positioning capability information of at least one second terminal device to the LMF if the ranging sidelink positioning capability request message carries an identity of at least one second terminal device.

Optionally, in an embodiment of the present disclosure, the sending module 1202 is further configured to: send a positioning capability request message to the at least one second terminal device if there is no available ranging sidelink positioning capability information of the at least one second terminal device in the first terminal device before feeding back the ranging sidelink positioning capability information of the at least one second terminal device to the LMF; and
receive ranging sidelink positioning capability information sent by the at least one second terminal device.

Optionally, in an embodiment of the present disclosure, the ranging sidelink positioning capability information refers to calculation capability information for performing ranging sidelink positioning for the first terminal device and at least one second terminal device through a direct communication PC5 interface.

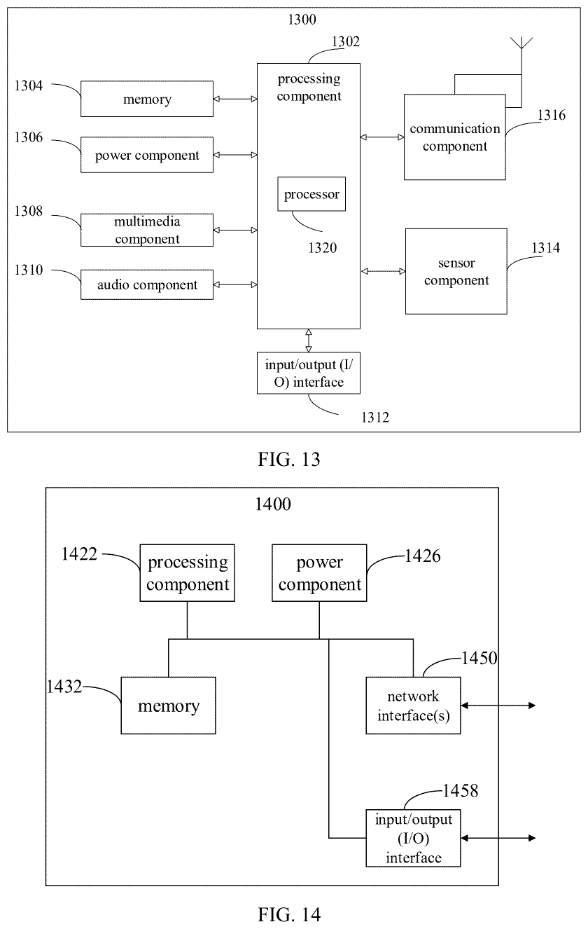

FIG. 13 is a block diagram of a terminal device UE 1300 according to an embodiment of the present disclosure. For example, the UE 1300 may be a mobile phone, a computer, digital broadcast terminal device, a messaging device, a gaming console, a tablet, a medical device, exercise equipment, a personal digital assistant, and the like.

Referring to FIG. 13, the UE 1300 may include at least one of the following components: a processing component 1302, a memory 1304, a power component 1306, a multimedia component 1308, an audio component 1310, an input/output (I/O) interface 1312, a sensor component 1314, and a communication component 1316.

The processing component 1302 typically controls overall operations of the UE 1300, such as the operations associated with display, telephone calls, data communications, camera operations, and recording operations. The processing component 1302 may include at least one processor 1320 to execute instructions to perform all or part of the steps in the above described methods. Moreover, the processing component 1302 may include at least one module which facilitates the interaction between the processing component 1302 and other components. For instance, the processing component 1302 may include a multimedia module to facilitate the interaction between the multimedia component 1308 and the processing component 1302.

The memory 1304 is configured to store various types of data to support the operation of the UE 1300. Examples of such data include instructions for any applications or methods operated on the UE 1300, contact data, phonebook data, messages, pictures, video, etc. The memory 1304 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1306 provides power to various components of the UE 1300. The power component 1306 may include a power management system, at least one power source, and any other components associated with the generation, management, and distribution of power in the UE 1300.

The multimedia component 1308 includes a screen providing an output interface between the UE 1300 and the user. In some embodiments, the screen may include a liquid crystal display (LCD) and a touch panel (TP). If the screen includes the touch panel, the screen may be implemented as a touch screen to receive input signals from the user. The touch panel includes at least one touch sensor to sense touches, swipes, and gestures on the touch panel. The touch sensor(s) may not only sense a boundary of a touch or swipe action, but also sense a period of wake-up time and a pressure associated with the touch or swipe action. In some embodiments, the multimedia component 1308 includes a front camera and/or a rear camera. The front camera and the rear camera may receive an external multimedia datum while the UE 1300 is in an operation mode, such as a photographing mode or a video mode. Each of the front camera and the rear camera may be a fixed optical lens system or have focus and optical zoom capability.

The audio component 1310 is configured to output and/or input audio signals. For example, the audio component 1310 includes a microphone (“MIC”) configured to receive an external audio signal when the UE 1300 is in an operation mode, such as a call mode, a recording mode, and a voice recognition mode. The received audio signal may be further stored in the memory 1304 or transmitted via the communication component 1316. In some embodiments, the audio component 1310 further includes a speaker to output audio signals.

The I/O interface 1312 provides an interface between the processing component 1302 and peripheral interface modules, such as a keyboard, a click wheel, buttons, and the like. The buttons may include, but are not limited to, a home button, a volume button, a starting button, and a locking button.

The sensor component 1314 includes at least one sensor to provide status assessments of various aspects of the UE 1300. For instance, the sensor component 1314 may detect an open/closed status of the UE 1300, relative positioning of components, e.g., the display and the keypad, of the UE 1300, a change in position of the UE 1300 or a component of the UE 1300, a presence or absence of user contact with the UE 1300, an orientation or an acceleration/deceleration of the UE 1300, and a change in temperature of the UE 1300. The sensor component 1314 may include a proximity sensor configured to detect the presence of nearby objects without any physical contact. The sensor component 1314 may also include a light sensor, such as a CMOS or CCD image sensor, for use in imaging applications. In some embodiments, the sensor component 1314 may also include an accelerometer sensor, a gyroscope sensor, a magnetic sensor, a pressure sensor, or a temperature sensor.

The communication component 1316 is configured to facilitate communication, wired or wirelessly, between the UE 1300 and other devices. The UE 1300 can access a wireless network based on a communication standard, such as WiFi, 2G, or 3G, or a combination thereof. In one example embodiment, the communication component 1316 receives a broadcast signal or broadcast associated information from an external broadcast management system via a broadcast channel. In one example embodiment, the communication component 1316 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In example embodiments, the UE 1300 may be implemented with at least one application specific integrated circuit (ASIC), digital signal processor (DSP), digital signal processing device (DSPD), programmable logic device (PLD), field programmable gate array (FPGA), controller, micro-controller, microprocessor, or other electronic component, for performing the above described methods.

FIG. 14 is a block diagram of a network side device 1400 provided by an embodiment of the present disclosure. For example, the network side device 1400 may be provided as a device at the network side. As shown in FIG. 14, the network side device 1400 includes a processing component 1422 that further includes at least one processor, and memory resources represented by a memory 1432 for storing instructions executable by the processing component 1422, such as application programs. The application programs stored in the memory 1432 may include one or more modules each corresponding to a set of instructions. Further, the processing component 1422 is configured to execute the instructions to perform any of the above described methods which are applied at the network side device, for example, the methods shown in FIG. 1.

The network side device 1400 may also include a power component 1426 configured to perform power management of the network side device 1400, wired or wireless network interface(s) 1450 configured to connect the network side device 900 to a network, and an input/output (I/O) interface 1458. The network side device 1400 may operate based on an operating system stored in the memory 1432, such as Windows Server™, Mac OS X™, Unix™, Linux™, FreeBSD™, or the like.

In the above embodiments provided by the present disclosure, the methods provided by the embodiments of the present disclosure are introduced from the perspectives of the network side device and the UE. In order to implement the functions in the methods provided by the above embodiments of the present disclosure, the network side device and the UE may include a hardware structure or a software module, and implement the above functions in the form of the hardware structure, the software module, or the hardware structure plus the software module. A certain function in the above functions may be implemented in the form of the hardware structure, the software module, or the hardware structure plus the software module.

In the above embodiments provided by the present disclosure, the methods provided by the embodiments of the present disclosure are introduced from the perspectives of the network side device and the UE. In order to implement the functions in the methods provided by the above embodiments of the present disclosure, the network side device and the UE may include a hardware structure or a software module, and implement the above functions in the form of the hardware structure, the software module, or the hardware structure plus the software module. A certain function in the above functions may be implemented in the form of the hardware structure, the software module, or the hardware structure plus the software module.

An embodiment of the present disclosure provides a communication apparatus. The communication apparatus may include a transceiving module and a processing module. The transceiving module may include a sending module and/or a receiving module, the sending module is configured to implement a sending function, the receiving module is configured to implement a receiving function, and the transceiving module may implement a sending function and/or a receiving function.

The communication apparatus may be a terminal device (such as the terminal device in the aforementioned method embodiments), or an apparatus in the terminal device, or an apparatus that can be used in conjunction with the terminal device. Alternatively, the communication apparatus may be a network device, or an apparatus in the network device, or an apparatus that can be used in conjunction with the network device.

An embodiment of the present disclosure provides another communication apparatus. The communication apparatus may be a network device, or a terminal device (such as the terminal device in the aforementioned method embodiments), or a chip, a chip system or a processor that supports a network device to implement the above methods, or a chip, a chip system or a processor that supports a terminal device to implement the above methods, etc. The apparatus may be configured to implement the methods described in the above method embodiments. For details, reference may be made to the descriptions in the above method embodiments.

The communication apparatus may include one or more processors. The processor(s) may be a general-purpose processor or a special-purpose processor, etc. For example, it can be a baseband processor or a central processor. The baseband processor may be used to process communication protocols and communication data, and the central processor may be used to control the communication apparatus (such as network side device, baseband chip, terminal device, terminal device chip, DU or CU, etc.), executes a computer program, and processes data for a computer program.

Optionally, the communication apparatus may further include one or more memories, on which a computer program may be stored, and the processor executes the computer program, so that the communication apparatus performs the methods described in the above method embodiments. Optionally, data may also be stored in the memory. The communication apparatus and the memory may be provided separately or integrated together.

Optionally, the communication apparatus may further include a transceiver and an antenna. The transceiver may be called a transceiving unit, a transceiving device, or a transceiving circuit, etc., and is configured to realize sending and receiving functions. The transceiver 1005 may include a receiver and a sender. The receiver may be called a receiving device or a receiving circuit, etc., and is configured to realize the receiving function; the sender may be called a sending device or a sending circuit, etc., and is configured to realize the sending function.

Optionally, the communication apparatus may further include one or more interface circuits. The interface circuits are configured to receive code instructions and transmit them to the processor. The processor executes the code instructions to cause the communication apparatus to perform the methods described in the above method embodiments.

The communication apparatus is a terminal device (such as the terminal device in the aforementioned method embodiments): the processor is configured to perform the method as shown in any one of FIG. 1 to FIG. 4.

The communication apparatus is a network side device: the processor is configured to perform the method as shown in any one of FIG. 5 to FIG. 7.

In one implementation, a transceiver for implementing receiving and sending functions may be included in the processor. For example, the transceiver may be a transceiving circuit, or an interface, or an interface circuit. The transceiving circuit, interface or interface circuit configured to implement the receiving and sending functions may be separate or integrated together. The above-mentioned transceiving circuit, interface or interface circuit may be used for reading and writing of codes/data, or the above-mentioned transceiving circuit, interface or interface circuit may be used for signal transmission or delivery.

In one implementation, the processor may store a computer program, and the computer program is run on the processor, causing the communication apparatus to perform the methods described in the above method embodiments. The computer program may be solidified in the processor, in which case the processor may be implemented in hardware.

In one implementation, the communication apparatus may include a circuit, and the circuit may implement the functions of sending or receiving or communicating in the foregoing method embodiments. The processor and transceiver described in the present disclosure may be implemented in Integrated Circuit (IC), analog IC, Radio Frequency Integrated Circuit (RFIC), mixed signal IC, Application Specific Integrated Circuit (ASIC), Printed Circuit Board (PCB), electronic device, and so on. The processor and transceiver may also be manufactured using various IC process technologies, such as Complementary Metal Oxide Semiconductor (CMOS), nMetal-Oxide-Semiconductor (NMOS), Positive Channel Metal Oxide Semiconductor (PMOS), Bipolar Junction Transistor (BJT), bipolar CMOS (BiCMOS), silicon germanium (SiGe), gallium arsenide (GaAs), etc.

The communication apparatus described in the above embodiments may be a network device, or a terminal device (such as the terminal device in the aforementioned method embodiments), but the scope of the communication apparatus described in the present disclosure is not limited thereto, and the structure of the communication apparatus is not limited by the structures described herein. The communication apparatus may be a stand-alone device or may be part of a larger device. For example, the communication apparatus may be:
(1) an independent integrated circuit (IC), or a chip, or a chip system or subsystem;
(2) a collection of one or more ICs; optionally, the IC collection may further include a storage component for storing data and computer programs;
(3) ASIC, such as modem;
(4) a module that can be embedded in other device(s);
(5) a receiver, a terminal device, an intelligent terminal device, a cellular phone, a wireless device, a handheld device, a mobile unit, a vehicle-mounted device, a network device, a cloud device, an artificial intelligence device, etc.;
(6) others, etc.

For a case where the communication apparatus can be a chip or a chip system, the chip includes a processor and an interface. The number of processors may be one or more, and the number of interfaces may be more than one.

Optionally, the chip further includes a memory, and the memory is configured to store necessary computer programs and data.

Those skilled in the art can also understand that the various illustrative logical blocks and steps listed in the embodiments of the present disclosure may be implemented by electronic hardware, computer software, or a combination of both. Whether such functionality is implemented in hardware or software depends on the specific application and overall system design requirements. Those skilled in the art can use various methods to implement the described functions for each specific application, but such implementation should not be understood as beyond the scope of protection of the embodiments of the present disclosure.

The present disclosure also provides a readable storage medium on which instructions are stored, and when the instructions are executed by a computer, the functions of any of the above method embodiments are implemented.

The present disclosure also provides a computer program product, which, when executed by a computer, implements the functions of any of the above method embodiments.

The above embodiments may be implemented in whole or in part by software, hardware, firmware, or any combination thereof. When implemented in software, the embodiments may be implemented in whole or in part in the form of a computer program product. The computer program product includes one or more computer programs. When the computer program is loaded and executed on a computer, processes or functions described in accordance with the embodiments of the present disclosure are generated in whole or in part. The computer may be a general-purpose computer, a special-purpose computer, a computer network, or other programmable device. The computer program may be stored in a computer-readable storage medium, or may be transferred from one computer-readable storage medium to another, for example, the computer program may be transferred from a website, computer, server, or data center to another website, computer, server or data center through wired (such as coaxial cable, optical fiber, Digital Subscriber Line (DSL)) or wireless (such as infrared, wireless, microwave, etc.) means. The computer-readable storage medium may be any available medium that can be accessed by a computer or a data storage device such as a server, data center, etc. that contains one or more available media integrated. The available medium may be magnetic medium (for example, floppy disk, hard disk, magnetic tape), optical medium (for example, high-density Digital Video Disc (DVD)), or semiconductor medium (for example, Solid State Disk (SSD)), etc.

Those of ordinary skill in the art can understand that first, second, and other numerical numbers involved in the present disclosure are only for convenience of description and are not used to limit the scope of the embodiments of the disclosure, nor to indicate a sequential order.

The term “at least one” in the present disclosure can also be described as one or a plurality of, and the plurality can be two, three, four or more, and the present disclosure is not limited thereto. In the embodiments of the present disclosure, for a kind of technical features, “first”, “second”, “third”, “A”, “B”, “C” and “D”, etc. are used to distinguish technical features in the kind of technical features, and technical features described associated with “first”, “second”, “third”, “A”, “B”, “C” and “D” are in no particular sequential order or order of size.

Other embodiments of the disclosure will be apparent to those skilled in the art from consideration of the specification and practice of the disclosure disclosed herein. The present disclosure is intended to cover any variations, uses, or adaptations of the present disclosure following the general principles thereof and including such departures from the present disclosure as come within known or customary practice in the art. It is intended that the specification and embodiments be considered as exemplary only, with a true scope and spirit of the present disclosure being indicated by the following claims.

It will be appreciated that the present disclosure is not limited to the exact structure that has been described above and illustrated in the accompanying drawings, and that various modifications and changes can be made without departing from the scope thereof. It is intended that the scope of the present disclosure is only limited by the appended claims.

1. A ranging/sidelink positioning method, wherein the method is performed by a Location Management Function (LMF) entity, and the method comprises:
sending a ranging/sidelink positioning capability request message to a first terminal device;
receiving a ranging/sidelink positioning capability response message fed back by the first terminal device, wherein the ranging/sidelink positioning capability response message comprises ranging/sidelink positioning capability information of at least one terminal device; and
according to the ranging/sidelink positioning capability response message, determining calculation information for performing ranging-/sidelink positioning for the first terminal device and at least one second terminal device.

2. The method according to claim 1, wherein determining calculation information for performing ranging-/sidelink positioning for the first terminal device and the at least one second terminal device comprises at least one of:
determining a calculation mode for performing ranging/sidelink positioning for the first terminal device and the at least one second terminal device; or
determining a calculation node for performing ranging/sidelink positioning for the first terminal device and the at least one second terminal device.

3. The method according to claim 2, wherein the calculation node comprises one of:
determining the at least one terminal device as the calculation node for the ranging/sidelink positioning;
determining the LMF as the calculation node for the ranging/sidelink positioning; or
determining the at least one terminal device and the LMF as the calculation node for the ranging/sidelink positioning.

4. The method according to claim 2, wherein the calculation mode comprises one of:
a calculation mode in which the at least one terminal device performs the ranging/sidelink positioning;
a calculation mode in which the LMF performs the ranging/sidelink positioning; or
a calculation mode in which the at least one terminal device and the LMF jointly perform the ranging/sidelink positioning.

5. The method according to claim 2, wherein determining the calculation node for performing ranging/sidelink positioning for the first terminal device and the at least one second terminal device comprises:
receiving a preferred calculation node for the ranging/sidelink positioning sent by the first terminal device;
if the preferred calculation node is the at least one terminal device, determining the at least one terminal device as the calculation node for performing ranging/sidelink positioning for the first terminal device and the at least one second terminal device;
if the preferred calculation node is the LMF, determining the LMF as the calculation node for performing ranging/sidelink positioning for the first terminal device and the at least one second terminal device; or
if the preferred calculation node is the at least one terminal device and the LMF, determining the at least one terminal device and the LMF as the calculation node for performing ranging/sidelink positioning for the first terminal device and the at least one second terminal device.

6. The method according to claim 1, wherein the at least one terminal device comprises the first terminal device and the at least one second terminal device;
wherein the ranging/sidelink positioning capability information comprises at least one of:
ranging/sidelink positioning capability information of the first terminal device among the at least one terminal device, wherein the first terminal device is a terminal device among the at least one terminal device that has a session connection with the LMF; or
ranging/sidelink positioning capability information of a second terminal device among the at least one terminal device, wherein the second terminal device is any terminal device among the at least one terminal device that performs ranging/sidelink positioning with the first terminal device.

7. The method according to claim 1, wherein determining calculation information for performing ranging/sidelink positioning for the first terminal device and the at least one second terminal device according to the ranging/sidelink positioning capability response message, comprises:
obtaining ranging/sidelink positioning capability information of the LMF; and
according to the ranging/sidelink positioning capability information of the at least one terminal device and the ranging/sidelink positioning capability information of the LMF, determining the calculation information for performing the ranging/sidelink positioning for the first terminal device and the at least one second terminal device.

8. The method according to claim 1, wherein sending the ranging/sidelink positioning capability request message to the first terminal device comprises:
receiving a ranging/sidelink positioning service request sent by an Access and Mobility management Function (AMF) entity;
in response to the ranging/sidelink positioning service request, determining whether the LMF has available ranging/sidelink positioning capability information of the first terminal device and the at least one second terminal device; and
in response to the LMF not having the available ranging/sidelink positioning capability information of the first terminal device and the at least one second terminal device, sending the ranging/sidelink positioning capability request message to the first terminal device.

9. The method according to claim 8, wherein the ranging/sidelink positioning capability request message carries the ranging/sidelink positioning capability information of the LMF as well as the an identity of the first terminal device and an identity of the at least one second terminal device.

10. The method according to claim 1, wherein the ranging/sidelink positioning capability information refers to calculation capability information for performing ranging/sidelink positioning for the first terminal device and the at least one second terminal device through a direct communication PC5 interface, comprising at least one of:
a calculation of a general relative distance between the first terminal device and any one of the at least one second terminal device;
a calculation of a general relative direction between the first terminal device and any one of the at least one second terminal device;
a calculation of a high-accuracy relative distance between the first terminal and any one of the at least one second terminal device;
a calculation of a high-accuracy relative direction between the first terminal and any one of the at least one second terminal device;
a calculation of a general relative distance between the first terminal and a plurality of the at least one second terminal device;
a calculation of a general relative direction between the first terminal and a plurality of the at least one second terminal device;
a calculation of a high-accuracy relative distance between the first terminal and a plurality of the at least one second terminal device; or
a calculation of a high-accuracy relative direction between the first terminal and a plurality of the at least one second terminal device;
wherein the first terminal device is a terminal device that has a session connection with the LMF, and the second terminal device is any terminal device among the at least one terminal device that performs ranging/sidelink positioning with the first terminal device.

11. A ranging/sidelink positioning method, wherein the method is performed by a first terminal device, and the method comprises:
receiving a ranging/sidelink positioning capability request message sent by a Location Management Function (LMF);
feeding back a ranging/sidelink positioning capability response message to the LMF, wherein the ranging/sidelink positioning capability response message comprises at least one of:
a preferred calculation node for ranging/sidelink positioning;
a calculation mode for the ranging/sidelink positioning; or
ranging/sidelink positioning capability information of at least one of the first terminal device or at least one second terminal device.

12. The method according to claim 11, further comprising:
according to ranging/sidelink positioning capability information of the LMF in the ranging/sidelink positioning capability request message, determining the preferred calculation node or a calculation mode for the ranging/sidelink positioning.

13. The method according to claim 11, further comprises:
in response to the ranging/sidelink positioning capability request message carrying an identity of the first terminal device, feeding ranging/sidelink positioning capability information of the first terminal device back to the LMF.

14. The method according to claim 11, further comprising:
in response to the ranging/sidelink positioning capability request message carrying an identity of at least one second terminal device, feeding ranging/sidelink positioning capability information of the at least one second terminal device back to the LMF.

15. The method according to claim 14, wherein before feeding the ranging/sidelink positioning capability information of the at least one second terminal device back to the LMF, the method further comprises:
in response to the first terminal device not having available ranging/sidelink positioning capability information of the at least one second terminal device, sending a positioning capability request message to the at least one second terminal device; and
receiving ranging/sidelink positioning capability information sent by the at least one second terminal device.

16. The method according to claim 11, wherein the ranging/sidelink positioning capability information refers to calculation capability information for performing ranging/sidelink positioning for the first terminal device and the at least one second terminal device through a direct communication PC5 interface.

17.-18. (canceled)

19. A terminal device, comprising a processor and a memory, wherein the memory stores a computer program, and execution of the computer program stored in the memory by the processor causes the device to perform the method according to claim 11.

20. A Location Management Function (LMF), comprising a processor and a memory, wherein the memory stores a computer program, and execution of the computer program stored in the memory by the processor causes the LMF to:
send a ranging/sidelink positioning capability request message to a first terminal device;
receive a ranging/sidelink positioning capability response message fed back by the first terminal device, wherein the ranging/sidelink positioning capability response message comprises ranging/sidelink positioning capability information of at least one terminal device; and
according to the ranging/sidelink positioning capability response message, determine calculation information for performing ranging/sidelink positioning for the first terminal device and at least one second terminal device.

21.-22. (canceled)

23. A non-transitory computer-readable storage medium configured to store instructions, wherein when the instructions are executed, the method according to claim 1 is implemented.

24. A non-transitory computer-readable storage medium configured to store instructions, wherein when the instructions are executed, the method according to claim 11 is implemented.
